(19) United States
(12) Patent Application Publication
(10) Pub. No.: US 2014/0037055 A1
(43) Pub. Date: Feb. 6, 2014

(54) RADIATION EMISSION TARGET, RADIATION GENERATING TUBE, AND RADIOGRAPHY SYSTEM

(71) Applicant: CANON KABUSHIKI KAISHA, Tokyo (JP)

(72) Inventors: Takao Ogura, Yokohama-shi (JP); Shuji Yamada, Atsugi-shi (JP); Yoichi Ikarashi, Fujisawa-shi (JP); Tadayuki Yoshitake, Tokyo (JP); Takeo Tsukamoto, Kawasaki-shi (JP)

(73) Assignee: CANON KABUSHIKI KAISHA, Tokyo (JP)

(21) Appl. No.: 13/957,127

(22) Filed: Aug. 1, 2013

(30) Foreign Application Priority Data
Aug. 6, 2012 (JP) 2012-173808

(51) Int. Cl. H01J 35/08; G01N 23/02

(52) U.S. Cl. CPC H01J 35/08; G01N 23/02
USPC 378/51; 378/143; 378/121

(57) ABSTRACT

A radiation emission target includes a target layer that generates radiation when irradiated with an electron beam and a substrate composed of diamond, the substrate supporting the target layer. The substrate has a Knoop hardness of 60 GPa or more and 150 GPa or less.

### BACKGROUND OF THE INVENTION

1. Field of the Invention

The present invention relates to a radiation emission target that generates radiation when hit by electrons, and a radiation generating unit and a radiography system that include the radiation emission target.

2. Description of the Related Art

Radiation generating units, which are used as a radiation source, generate radiation in a vacuum by emitting electrons from an electron source and colliding the electrons with a target layer composed of a material having a high atomic number, such as tungsten.

Examples of these radiation generating units include a radiation generating unit that includes a reflection-type radiation emission target and a radiation generating unit that includes a transmission-type radiation emission target.

The reflection-type radiation emission target includes, for example, a target layer composed of tungsten or the like, which emits radiation when irradiated with an electron beam; and a supporting substrate composed of copper or the like, which has high thermal conductivity and supports the target layer. The reflection-type radiation emission target is disposed obliquely relative to the direction of the electron beam and emits radiation in a direction substantially perpendicular to the direction of the electron beam. This radiation is used in radiography. Thus, the thicknesses and materials of the target layer and supporting substrate are less likely to practically affect the quality of the radiation used in radiography. Therefore, the thickness of the supporting substrate can be increased to some extent in order to improve the heat resistance of the radiation emission target.

The transmission-type radiation emission target includes, for example, a supporting substrate composed of beryllium or the like, through which radiation easily transmits; and a target layer that is a thin film composed of tungsten or the like, which is disposed on the supporting substrate and emits radiation when irradiated with an electron beam. The transmission-type radiation emission target is disposed perpendicularly to the direction of the electron beam and emits radiation in the same direction as the direction of the electron beam. This radiation is used in radiography. Thus, the thicknesses and materials of the target layer and supporting substrate may affect the quality of the radiation used in radiography. Therefore, it is almost impossible to increase the thicknesses of the target layer and the supporting substrate in order to improve the heat resistance of the radiation emission target. Thus, the transmission-type radiation emission target has a problem in that high heat resistance cannot be easily achieved.

In order to address the above-described problem, PCT Japanese Translation Patent Publication No. 2003-505845 (hereinafter, referred to as “Patent Document 1”) proposes a radiation emission target including a diamond supporting substrate. According to Patent Document 1, the radiation emission target includes a target layer disposed on one side of the diamond supporting substrate. The radiation emission target is incorporated into a radiation generating tube as a part of the external wall of the radiation generating tube so that the target layer faces the inside of the radiation generating tube. The diamond supporting substrate also functions as a seal window that maintains a vacuum and that allows radiation to exit therethrough. Diamond, having a markedly high thermal conductivity relative to other materials such as beryllium used as supporting substrates, allows heat generated in the target layer to rapidly dissipate into the supporting substrate. Patent Document 1 also describes that an interlayer may be disposed in order to improve the adhesion between the target layer and the supporting substrate. Thus, a transmission-type radiation emission target having improved heat resistance compared with the existing technology has been proposed.

A diamond supporting substrate used in a transmission-type radiation emission target allows heat generated in the target layer irradiated with an electron beam to rapidly dissipate into the diamond supporting substrate. Therefore, at a relatively early stage, a stable amount of radiation can be generated even when the transmission-type radiation emission target is used repeatedly, and no serious problem is found.

However, the longer the operation time is, the lower the amount of radiation is. Thus, in order to make practical use of the transmission-type radiation emission target, a period during which a stable amount of radiation can be generated needs to be further increased.

The present invention provides a transmission-type radiation emission target including a diamond supporting substrate, the radiation emission target producing a stable amount of radiation over a prolonged period. The present invention also provides a radiation generating unit and a radiography system that produce a stable amount of radiation over a prolonged period.

### SUMMARY OF THE INVENTION

A radiation emission target according to a first aspect of the present invention includes a target layer that generates radiation when irradiated with an electron beam and

a substrate composed of diamond, the substrate supporting the target layer.
The substrate has a Knoop hardness of 60 GPa or more and 150 GPa or less.

A radiation generating tube according to a second aspect of the present invention includes an electron emission source including an electron emission portion, a vacuum vessel housing the electron emission portion, and a radiation emission target including a target layer and a substrate in order of increasing distance from the electron emission portion.

The radiation emission target is the radiation emission target according to the first aspect of the present invention.

A radiography system according to a third aspect of the present invention includes a radiation generation apparatus including the radiation generating tube according to the second aspect of the present invention, a radiation detection apparatus that detects radiation that has been emitted from the radiation generating tube and has transmitted through an object, and

a controller that performs collaborative control of the radiation generation apparatus and the radiation detection apparatus.

Further features of the present invention will become apparent from the following description of exemplary embodiments with reference to the attached drawings.

### BRIEF DESCRIPTION OF THE DRAWINGS

FIG. 1 is a cross-sectional view illustrating a radiation generating unit according to an embodiment of the present invention.

FIGS. 2A and 2B are cross-sectional views illustrating, respectively, first and second examples of a radiation emission target according to the present invention.

FIG. 3 is a cross-sectional view illustrating another example of a radiation generating tube included in a radiation generating unit according to the present invention.

FIG. 4 is a diagram illustrating a radiography system according to an embodiment of the present invention, which includes a radiation generating unit according to the present invention.

### DESCRIPTION OF THE EMBODIMENTS

Hereinafter, exemplary embodiments of the present invention will now be described in detail with reference to the attached drawings. Materials, dimensions, shapes, relative positions, etc., of the components described in the following embodiments are not intended to limit the invention unless otherwise stated. In the following drawings, similar components are identified by the same reference numerals.

### Radiation Generating Unit

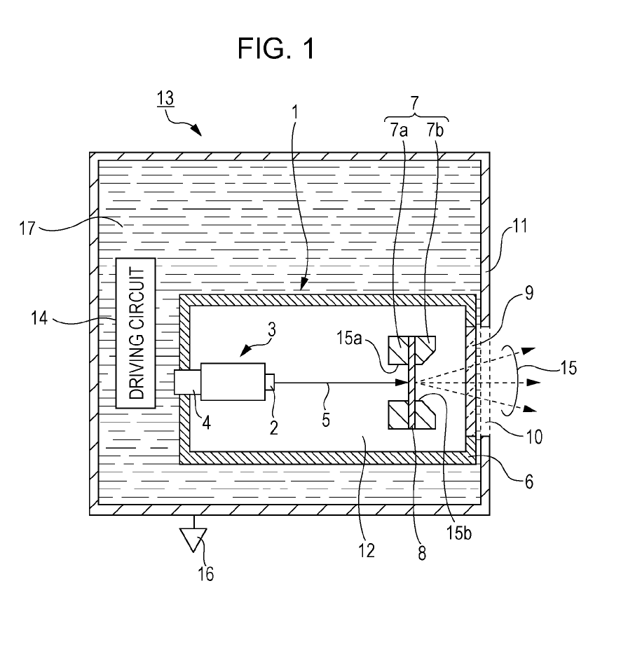

In this embodiment, as shown in FIG. 1, a radiation generating unit 13 includes a package 11 having an emission window 10 through which radiation is emitted. In the package 11, a radiation generating tube 1 and a driving circuit 14 are disposed. An extra space 17 inside the package 11 is filled with insulating oil (not shown). The package 11 has a grounding terminal 16.

The package 11 may be composed of a relatively high-strength material, such as iron, stainless steel, or brass, since the package 11 houses the radiation generating tube 1, the driving circuit 14, and insulating oil (not shown). Optionally, a material capable of blocking radiation, such as lead, may be disposed on part or all of the periphery of the package 11.

The emission window 10 of the package 11 allows radiation emitted from the radiation generating tube 1 to exit from the radiation generating unit 13 therethrough. The emission window 10 may be composed of a plastic containing no heavy elements, such as an acrylic resin or polymethylmethacrylate.

The radiation generating tube 1 includes a vacuum vessel 6 having a transmission window 9 through which radiation transmits, an electron emission source 3, and a radiation emission target 8 held by a shield 7. The electron emission source 3 includes a current introduction terminal 4 and an electron emission portion 2. The electron emission portion 2 of the electron emission source 3 and the radiation emission target 8 held by the shield 7 are disposed in the vacuum vessel 6 so as to face each other.

The electron emission source 3 may have any electron emission mechanism as long as the amount of electrons emitted is controllable from the outside of the vacuum vessel 6. For example, a hot-cathode electron emission source or a cold-cathode electron emission source may be employed as appropriate. The electron emission source 3 is electrically connected to the driving circuit 14 disposed outside the vacuum vessel 6 via the current introduction terminal 4 that penetrates through the vacuum vessel 6. This allows control of the amount of electrons emitted and the ON/OFF state of electron emission.

Electrons emitted from the electron emission portion 2 of the electron emission source 3 are accelerated by an extraction grid and an accelerating electrode (not shown) to form an electron beam 5 having an energy of about 10 to 200 keV, which is capable of hitting the radiation emission target 8. The extraction grid and the accelerating electrode may be incorporated in a hot-cathode electron gun used as the electron emission source 3. The electron emission source 3 may optionally include a correction electrode that performs adjustment of irradiation spot position of the electron beam 5 and astigmatic adjustment of the electron beam 5, the correction electrode being connected to an external correction circuit (not shown). The radiation emission target 8 is clamped between a rear shield 7a and a front shield 7b that constitute the shield 7 and faces the electron emission portion 2.

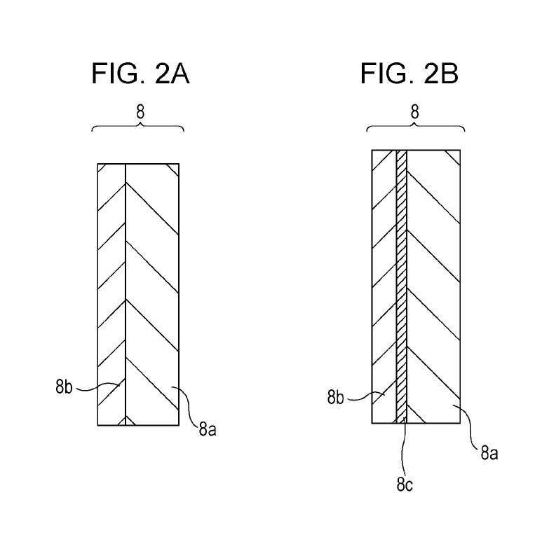

As shown in FIGS. 2A and 2B, the radiation emission target 8 includes a single-crystal diamond supporting substrate 8a containing 2 to 800 ppm nitrogen and a target layer 8b formed on the supporting substrate 8a. The supporting substrate 8a is composed of single-crystal diamond having a Knoop hardness of 60 to 150 GPa. The radiation emission target 8 is arranged in such a manner that the target layer 8b faces the electron emission portion 2 of the electron emission source 3 (see FIG. 1). The radiation emission target 8 will be described in detail below.

The shield 7 includes the rear shield 7a and the front shield 7b. The front shield 7b has an opening 15b that allows, among radiation emitted from an electron beam irradiation region (radiation generation region) of radiation emission target 8 in all directions, only desired radiation (arrow with broken line) emitted forward to exit. The front shield 7b also functions as a shield blocking radiation emitted forward other than the desired radiation. The rear shield 7a has an electron beam introduction hole 15a through which the electron beam 5 reaches the electron beam irradiation region of the radiation emission target 8. The rear shield 7a also functions as a shield blocking some of the radiation emitted backward among radiation emitted from the electron beam irradiation region in all directions.

The shield 7 may be composed of a material having a certain electric conductivity and a certain thermal conductivity. The shield 7 may be one capable of blocking radiation having an energy of 30 to 150 keV. The shield 7 may be composed of, for example, tungsten, tantalum, molybdenum, zirconium, niobium, or an alloy thereof. In this case, the shield 7 may exhibit such a blocking effect while maintaining a thickness of 0.5 to several millimeters.

The shield 7 and the radiation emission target 8 may be joined with each other by brazing. A brazing material used for the brazing may be selected as appropriate depending on the material of the shield 7, the allowable temperature limit of the shield 7, and the like. For example, in the case where the temperature of the radiation emission target 8 is considerably increased, a Cr—V-based alloy, a Ti—Ta—Mo-based alloy, a Ti—V—Cr—Al-based alloy, a Ti—Cr-based alloy, a Ti—Zr—Be-based alloy, a Zr—Nb—Be-based alloy, or the like may be used as a brazing metal for a high-melting point metal. Other examples of the brazing material include a brazing material containing a Au—Cu alloy as a main component, a nickel solder, a brass solder, a silver solder, and a palladium solder.

The vacuum vessel 6 may be composed of glass, a ceramic, or the like. The vacuum vessel 6 has an internal space 12 that has been evacuated (depressurized).

The transmission window 9 allows radiation generated in the radiation emission target 8 to transmit therethrough and then to exit to the outside through the emission window 10. Thus, the transmission window 9 may be composed of a material capable of maintaining an adequate degree of vacuum inside the radiation generating tube 1 and capable of minimizing attenuation of radiation that transmits through the transmission window 9. Examples of such a material include beryllium, carbon, diamond, and glass, which may contain no heavy elements.

The internal space 12 of the vacuum vessel 6 may be maintained at a degree of vacuum such that the mean free path of electrons is maintained, in other words, electrons can fly over a distance between the electron emission portion 2 of the electron emission source 3 and the radiation emission target 8 that emits radiation. Such a degree of vacuum may be 10⁻⁴ Pa or less. The degree of vacuum may be selected as appropriate in consideration of the type of electron emission source 3 used, the operational temperature, and the like. In the case where a cold-cathode electron emission source or the like is used, the degree of vacuum may be 10⁻⁶ Pa or less. Optionally, in order to maintain the degree of vacuum, a getter (not shown) may be installed in the internal space 12 or in an additional space that communicates with the internal space 12.

The structure of the radiation emission target 8 will now be described with reference to FIGS. 2A and 2B.

FIG. 2A illustrates an example of the radiation emission target 8 prepared by forming the target layer 8b on the single-crystal diamond supporting substrate 8a containing 2 to 800 ppm nitrogen.

Diamond is a substance having high hardness but not high resistance to impact. These properties can be controlled to some extent by changing the nitrogen content. Although diamond containing 2 to 800 ppm nitrogen has a smaller Knoop hardness of generally 60 to 150 GPa than diamond having a nitrogen content of less than 2 ppm or more than 800 ppm, it is considered to have high resistance to impact. For example, diamond containing 1 ppm or less nitrogen has a Knoop hardness of generally 200 to 250 GPa, which results from the strength of diamond bonding. Diamond containing 1000 ppm or more nitrogen has a Knoop hardness of generally 180 to 250 GPa and contains many lattice defects, which is considered to reduce dislocation mobility.

Single-crystal diamond containing 2 to 800 ppm nitrogen is considered to be less likely to develop microcracks due to thermal shock when used as the supporting substrate 8a of the radiation emission target than single-crystal diamond containing 1 ppm or less or 1000 ppm or more nitrogen.

In particular, when the target layer 8b is formed by a PVD method, such as sputtering, the adhesion between the target layer 8b and the diamond supporting substrate 8a is improved. The reason for this is not clear but is probably that the surface of the supporting substrate 8a is slightly deformed during the sputtering, and this improves the adhesion.

The target layer 8b may be generally composed of a material having an atomic number of 26 or more. A material having a higher thermal conductivity and a higher melting point may be used. Specifically, films composed of metal materials such as tungsten, molybdenum, chromium, copper, cobalt, iron, rhodium, and rhenium or alloy materials thereof may be used. The optimal thickness of the target layer 8b varies depending on an acceleration voltage because the penetration depth of an electron beam into the target layer 8b, that is, the radiation generation region varies depending on the acceleration voltage. Generally, the thickness of the target layer 8b is 1 μm or more and 15 μm or less.

FIG. 2B illustrates another example of the radiation emission target 8 prepared by forming an adhesion layer 8c that is composed of titanium, chromium, or the like on the single-crystal diamond supporting substrate 8a and then forming the target layer 8b on the adhesion layer 8c. The adhesion layer 8c improves the adhesion between the supporting substrate 8a and the target layer 8b. The interposition of the adhesion layer 8c improves the adhesion between the supporting substrate 8a and the target layer 8b and also improves the stability of radiation generation over time.

### Another Example of Radiation Generating Tube

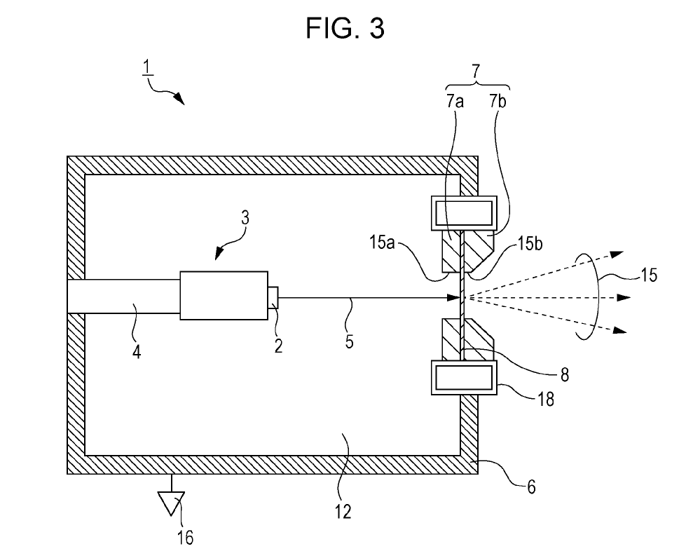

In this example, as shown in FIG. 3, the radiation emission target 8 also functions as the transmission window 9 of the vacuum vessel 6 (see FIG. 1). The shield 7 that holds the radiation emission target 8 and the vacuum vessel 6 are connected with each other through a flange 18. Thus, a vacuum is maintained. When the radiation generating tube has such a structure, the transmission window 9 of the vacuum vessel 6 (see FIG. 1) can be omitted, which advantageously reduces the attenuation of radiation. Other components of this radiation generating tube are same as the radiation generating tube 1 shown in FIG. 1.

### Radiography System

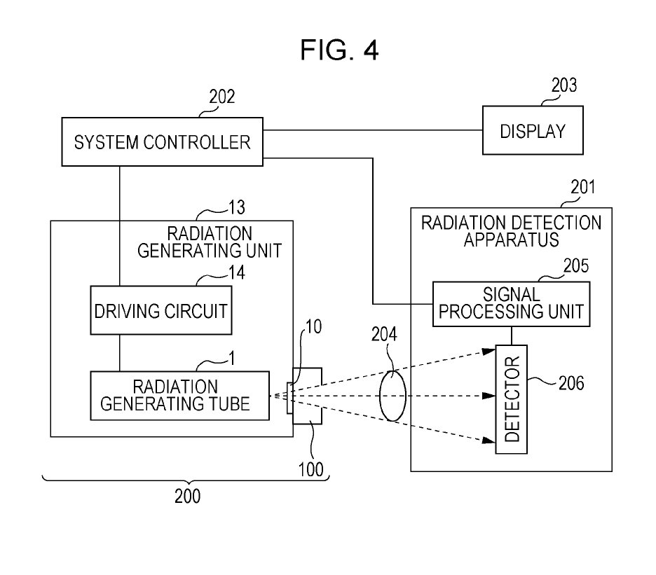

A radiography system according to an embodiment of the present invention is described with reference to FIG. 4.

In this embodiment, the radiation generating unit 13 described above and an movable aperture unit 100 disposed in the vicinity of the emission window 10 constitute a radiation generation apparatus 200. The movable aperture unit 100 has a function of adjusting the radiation field size of radiation emitted from the radiation generating unit 13. Optionally, the movable aperture unit 100 may have a function of displaying the radiation field with visible light.

A system controller 202 performs collaborative control of the radiation generation apparatus 200 and a radiation detection apparatus 201. A driving circuit 14 outputs various control signals to the radiation generating tube 1 under control of the system controller 202. The radiation state of radiation emitted from the radiation generation apparatus 200 is controlled in accordance with the control signals. The radiation emitted from the radiation generation apparatus 200 transmits through an object 204 and detected by a detector 206. The detector 206 converts the detected radiation into an image signal and outputs the image signal to a signal processing unit 205. The signal processing unit 205 executes predetermined signal processing on the image signal and outputs the processed image signal to the system controller 202 under control of the system controller 202. In accordance with the processed image signal, the system controller 202 outputs, to a display 203, a display signal for displaying an image on the display 203. The display 203 displays, as a captured image of the object 204, an image based on the display signal on a screen. A representative example of radiation is X-ray. The radiation generating unit 13 and the radiography system according to the present invention may be used as an X-ray generating unit and X-ray imaging system, respectively. The X-ray imaging system can be used in nondestructive testing of industrial products and in pathological diagnosis of human bodies and animals.

### EXAMPLES

In Examples and Comparative Examples described below, a supporting substrate was prepared by grinding single-crystal diamond having a respective nitrogen content to a thickness of 1 mm and subsequently cutting it with a laser into a disk shape having a diameter of 3 mm. The nitrogen content and the Knoop hardness of the cut-off piece of the supporting substrate were measured. The measured values were considered as the nitrogen content and the Knoop hardness of the supporting substrate. The nitrogen content was measured with a nitrogen/oxygen analyzer. The Knoop hardness was measured with a microhardness testing machine using a Knoop indenter.

In both Examples and Comparative Examples, a radiation generating tube was prepared as follows. As shown in FIG. 1, a radiation emission target 8 was integrally attached to a shield 7 composed of tungsten. Then, the radiation emission target 8 was arranged to face an electron emission source 3, which is an impregnated thermionic-emission gun, having an electron emission portion 2. Subsequently, a getter (not shown) was installed inside a vacuum vessel 6. The vacuum vessel 6 was sealed in a vacuum to form a radiation generating tube 1.

The generation and measurement of radiation were conducted as follows. In both Examples and Comparative Examples, the amount of radiation emitted from the radiation generating tube was measured with a semiconductor-type dosimeter. In Examples 1 to 6 and Comparative Examples 1 to 3 and 5, the radiation generating tube was continuously operated under the following conditions: acceleration voltage of 100 kV, current of 2 mA, irradiation time of 10 msec, and rest time of 90 msec. In Example 7 and Comparative Example 4, the radiation generating tube was continuously operated under the following conditions: acceleration voltage of 30 kV, current of 2 mA, irradiation time of 10 msec, and rest time of 90 msec.

Hereinafter, for each of Examples and Comparative Examples, the conditions for preparing the radiation emission target will be described.

### Example 1

A single-crystal diamond supporting substrate containing 2 ppm nitrogen and having a Knoop hardness of 150 GPa was previously subjected to UV-ozone asking to remove organic matters on the surface of the supporting substrate. Subsequently, a tungsten layer having a thickness of 5 μm was formed as a target layer on the supporting substrate by sputtering.

### Example 2

A single-crystal diamond supporting substrate containing 50 ppm nitrogen and having a Knoop hardness of 100 GPa was previously subjected to UV-ozone ashing to remove organic matters on the surface of the supporting substrate. Subsequently, a tungsten layer having a thickness of 5 μm was formed as a target layer on the supporting substrate by sputtering.

### Example 3

A single-crystal diamond supporting substrate containing 50 ppm nitrogen and having a Knoop hardness of 100 GPa was previously subjected to UV-ozone ashing to remove organic matters on the surface of the supporting substrate. Subsequently, a chromium layer having a thickness of 50 nm was formed as an adhesion layer on the supporting substrate by sputtering. Then, a tungsten layer having a thickness of 5 μm was formed as a target layer on the chromium layer by sputtering.

### Example 4

A single-crystal diamond supporting substrate containing 50 ppm nitrogen and having a Knoop hardness of 100 GPa was previously subjected to UV-ozone ashing to remove organic matters on the surface of the supporting substrate. Subsequently, a tungsten layer having a thickness of 5 μm was formed as a target layer on the supporting substrate by a CVD method.

### Example 5

A single-crystal diamond supporting substrate containing 200 ppm nitrogen and having a Knoop hardness of 60 GPa was previously subjected to UV-ozone ashing to remove organic matters on the surface of the supporting substrate. Subsequently, a tungsten layer having a thickness of 5 μm was formed as a target layer on the supporting substrate by sputtering.

### Example 6

A single-crystal diamond supporting substrate containing 800 ppm nitrogen and having a Knoop hardness of 140 GPa was previously subjected to UV-ozone ashing to remove organic matters on the surface of the supporting substrate. Subsequently, a tungsten layer having a thickness of 5 μm was formed as a target layer on the supporting substrate by sputtering.

### Example 7

A single-crystal diamond supporting substrate containing 50 ppm nitrogen and having a Knoop hardness of 110 GPa was previously subjected to UV-ozone ashing to remove organic matters on the surface of the supporting substrate. Subsequently, a molybdenum layer having a thickness of 3 μm was formed as a target layer on the supporting substrate by sputtering.

### Comparative Example 1

A single-crystal diamond supporting substrate containing 0.5 ppm nitrogen and having a Knoop hardness of 200 GPa was previously subjected to UV-ozone ashing to remove organic matters on the surface of the supporting substrate. Subsequently, a tungsten layer having a thickness of 5 μm was formed as a target layer on the supporting substrate by sputtering.

### Comparative Example 2

A single-crystal diamond supporting substrate containing 0.5 ppm nitrogen and having a Knoop hardness of 200 GPa was previously subjected to UV-ozone ashing to remove organic matters on the surface of the supporting substrate. Subsequently, a tungsten layer having a thickness of 5 μm was formed as a target layer on the supporting substrate by a CVD method.

### Comparative Example 3

A single-crystal diamond supporting substrate containing 1000 ppm nitrogen and having a Knoop hardness of 180 GPa was previously subjected to UV-ozone ashing to remove organic matters on the surface of the supporting substrate. Subsequently, a tungsten layer having a thickness of 5 μm was formed as a target layer on the supporting substrate by sputtering.

### Comparative Example 4

A single-crystal diamond supporting substrate containing 0.5 ppm nitrogen and having a Knoop hardness of 200 GPa was previously subjected to UV-ozone ashing to remove organic matters on the surface of the supporting substrate. Subsequently, a molybdenum layer having a thickness of 3 μm was formed as a target layer on the supporting substrate by sputtering.

### Comparative Example 5

A polycrystalline diamond supporting substrate containing 100 ppm nitrogen and having a Knoop hardness of 40 GPa prepared by a CVD method was used. This supporting substrate was previously subjected to UV-ozone asking to remove organic matters on the surface of the supporting substrate. Subsequently, a tungsten layer having a thickness of 5 μm was formed as a target layer on the supporting substrate by sputtering.

### Evaluation Results

Table 1 summarizes the features of the radiation emission target included in each radiation generating tube of Examples 1 to 7 and Comparative Examples 1 to 5. Table 2 summarizes the change in the amount of radiation emitted from each radiation generating tube of Examples 1 to 7 and Comparative Examples 1 to 5.

In Table 2, the amount of radiation measured 1 hour after the beginning of the continuous operation is defined as 100, and the change in the amount of radiation thereafter is shown. In Examples 1 to 6, the amount of radiation emitted from the radiation generating tube decreased with elapsed operation time and reached 86% to 91% of the initial value after 500 hours. The decrease was particularly small in the radiation generating tube of Example 3, which included an adhesion layer composed of chromium.

On the other hand, in Comparative Examples 1 to 3 and 5, the decrease in the amount of radiation emitted from the radiation generating tube was larger than in Examples described below. The amount of radiation emitted from the radiation generating tube reached 63% to 72% of the initial value after 500 hours. The decrease was particularly large in Comparative Example 3, where the target layer was formed by a CVD method, and in Comparative Example 5, where the supporting substrate was composed of polycrystalline diamond.

In Example 7 and Comparative Example 4, where the target layer was composed of molybdenum, the change in the amount of radiation emitted from the radiation generating tube was, after 500 hours, substantially same as in the case where the target layer was composed of tungsten. This proves that molybdenum has the same effect as tungsten.

TABLE 1

| | | | | | Target | | |
|---|---|---|---|---|---|---|---|
| | | Nitrogen | Knoop | Target | layer | | |
| | | content | hardness | layer | thickness | Adhesion | Deposition |
| | Diamond type | (ppm) | (GPa) | element | (μm) | layer | method |
| Example 1 | Single crystal | 2 | 150 | W | 5 | None | Sputtering |
| Example 2 | Single crystal | 50 | 100 | W | 5 | None | Sputtering |
| Example 3 | Single crystal | 50 | 100 | W | 5 | None | Sputtering |
| Example 4 | Single crystal | 50 | 100 | W | 5 | Cr | CVD |
| Example 5 | Single crystal | 200 | 60 | W | 5 | None | Sputtering |
| Example 6 | Single crystal | 800 | 140 | W | 5 | None | Sputtering |
| Example 7 | Single crystal | 50 | 110 | Mo | 3 | None | Sputtering |
| Comparative | Single crystal | 0.5 | 200 | W | 5 | None | Sputtering |
| Example 1 | | | | | | | |
| Comparative | Single crystal | 0.5 | 200 | W | 5 | None | CVD |
| Example 2 | | | | | | | |
| Comparative | Single crystal | 1000 | 180 | W | 5 | None | Sputtering |
| Example 3 | | | | | | | |
| Comparative | Single crystal | 0.5 | 200 | Mo | 3 | None | Sputtering |
| Example 4 | | | | | | | |
| Comparative | Polycrystalline | 100 | 40 | W | 5 | None | Sputtering |
| Example 5 | | | | | | | |

TABLE 2

| | Operation time | | | | | |
|---|---|---|---|---|---|---|
| | 1 hr | | | | | |
| | (initial) | 100 hr | 200 hr | 300 hr | 400 hr | 500 hr |
| Example 1 | 100 | 97 | 92 | 90 | 88 | 86 |
| Example 2 | 100 | 99 | 92 | 91 | 90 | 88 |
| Example 3 | 100 | 99 | 97 | 96 | 93 | 91 |
| Example 4 | 100 | 98 | 92 | 88 | 90 | 87 |
| Example 5 | 100 | 98 | 95 | 92 | 90 | 88 |
| Example 6 | 100 | 99 | 92 | 88 | 90 | 86 |
| Example 7 | 100 | 98 | 95 | 92 | 90 | 88 |
| Comparative | 100 | 95 | 89 | 82 | 75 | 70 |
| Example 1 | | | | | | |
| Comparative | 100 | 95 | 85 | 80 | 72 | 65 |
| Example 2 | | | | | | |
| Comparative | 100 | 95 | 90 | 82 | 77 | 72 |
| Example 3 | | | | | | |
| Comparative | 100 | 95 | 90 | 83 | 78 | 72 |
| Example 4 | | | | | | |
| Comparative | 100 | 95 | 85 | 80 | 70 | 63 |
| Example 5 | | | | | | |

The radiation emission target according to the present invention is markedly less likely to develop microcracks in the diamond supporting substrate due to thermal stress resulting from repeated use. Therefore, the adhesion of the target layer does not decrease even in the case of repeated use. Thus, a stable amount of radiation may be produced over a prolonged period.

The radiation emission target according to the present invention includes the target layer formed by a PVD method, which may improve the adhesion between the diamond supporting substrate and the target layer. Thus, a stable amount of radiation may be produced over a more prolonged period.

The radiation generating unit and the radiography system that include the radiation emission target according to the present invention may produce a stable amount of radiation over a prolonged period and thus exhibit improved practical performance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-173808 filed Aug. 6, 2012, which is hereby incorporated by reference herein in its entirety.

What is claimed is:

1. A radiation emission target comprising:
a target layer that generates radiation when irradiated with an electron beam; and
a substrate composed of diamond, the substrate supporting the target layer,
wherein the substrate has a Knoop hardness of 60 GPa or more and 150 GPa or less.

2. The radiation emission target according to claim 1, wherein the substrate has a nitrogen content of 2 ppm or more and 800 ppm or less.

3. The radiation emission target according to claim 1, wherein the substrate is composed of single-crystal diamond.

4. The radiation emission target according to claim 1, wherein the target layer is formed by a sputtering method.

5. The radiation emission target according to claim 1, wherein the target layer is composed of tungsten, molybdenum, rhodium, palladium, or an alloy thereof.

6. The radiation emission target according to claim 1, wherein the target layer has a thickness of 1 μm or more and 15 μm or less.

7. The radiation emission target according to claim 1, further comprising an adhesion layer interposed between the substrate and the target layer.

8. A radiation generating tube comprising:
an electron emission source including an electron emission portion;
a vacuum vessel housing the electron emission portion; and
a radiation emission target including a target layer and a substrate in order of increasing distance from the electron emission portion,
wherein the radiation emission target is the radiation emission target according to claim 1.

9. A radiography system comprising:
a radiation generation apparatus including the radiation generating tube according to claim 8;
a radiation detection apparatus that detects radiation that has been emitted from the radiation generating tube and has transmitted through an object; and
a controller that performs collaborative control of the radiation generation apparatus and the radiation detection apparatus.
